(19) United States
(12) Patent Application Publication
(10) Pub. No.: US 2025/0369256 A1
(43) Pub. Date: Dec. 4, 2025

(54) Emergency-Deployable Secondary Door Lock System with External Status Indication and Method of Use

(71) Applicant: Jerry N. Fields, Dallas, GA (US)

(72) Inventor: Jerry N. Fields, Dallas, GA (US)

(21) Appl. No.: 19/222,500

(22) Filed: May 29, 2025

Related U.S. Application Data
(60) Provisional application No. 63/652,820, filed on May 29, 2024.

(51) Int. Cl. E05B 41/00; E05B 17/10; E05B 45/06; E05B 47/00; E05B 65/10; E05C 3/22

(52) U.S. Cl. CPC E05B 41/00; E05B 17/10; E05B 45/06; E05B 47/0012; E05B 65/1086; E05C 3/22; E05B 2045/0695; E05B 2047/0058; E05B 2047/0069; E05B 2047/0094

(57) ABSTRACT

An emergency-deployable door lock system configured to reinforce a door against unauthorized entry during high-risk events. The system includes a locking mechanism mounted to either the door or the frame and a strike receiver mounted to the other, with a rotatable turning latch configured to engage the strike receiver when activated. The locking mechanism may be engaged manually via a thumb turn or remotely via a wireless signal received from a handheld remote control. A status light is coupled to the locking mechanism and configured to indicate lock state by emitting light patterns or colors. The system may optionally include an interior-facing camera and be powered by either a dedicated battery or a hardwired power source. The device may be optimally retrofitted for installation in schools, offices, and other facilities where rapid lockdown and visual lock-status confirmation are important to occupant safety.

### CROSS REFERENCE TO RELATED APPLICATIONS

To the full extent permitted by law, the present United States Non-Provisional Patent Application hereby claims priority to and the full benefit of, U.S. Provisional Application No. 63/652,820, filed May 29, 2024, entitled “G.L.A.S.S. GUIDING LIGHT ACTIVE SHOOTER SECURITY”, which is incorporated herein by reference in its entirety.

### FIELD OF THE DISCLOSURE

The present disclosure generally relates to electronic locking mechanisms, specifically a remotely activated secondary locking system for emergency deployment with status indication and monitoring.

### BACKGROUND OF THE DISCLOSURE

A recent and persistent rise in incidents of forced intrusions and mass casualty events in public buildings, including but not limited to schools, offices, and government facilities, have increased the need and desire for enhanced door security systems that can be deployed rapidly and reliably under duress. While many such facilities already employ conventional locking mechanisms (e.g., cylindrical, mortise, or deadbolt locks), these primary locks are often insufficient in deterring or delaying aggressive entry attempts, particularly when perpetrators are armed or familiar with basic breaching techniques. Additionally, such locks may not be present on certain interior doors or they may lack certain functions, such as exterior status indication and/or remote activation.

To address this vulnerability, various secondary lock mechanisms have been proposed. Some employ wedge devices, horizontal bar locks, or portable door braces, each aiming to supplement existing hardware in emergency scenarios and/or increase strength of primary locking capabilities. However, these systems often suffer from significant limitations. Many require manual deployment, which may be difficult under stress during emergent scenarios and/or panic. Others may be difficult to engage quickly, especially when a supervising adult may be positioned distantly from the locking mechanism, such as in a classroom. Additionally to this point, most offer no remote activation capability and require physical interaction with the door and/or locking mechanism, which can result in certain vulnerability for the operator. Furthermore, few provide visual or electronic feedback as to their status to those exterior to the door. So, while someone inside may easily visually determine the status of the lock simply by looking at its engagement and/or the thumb turn, those exterior to the door, such as law enforcement clearing a building, may not easily determine a locked/unlocked status without attempting to engage the door (i.e., trying to open it). Moreover, most, if not all physical systems providing secondary locking capabilities lack integration with surveillance or communication technologies, which could otherwise provide situational awareness to first responders or building security personnel during these types of scenarios. Finally, even certain “smart” or software integrated locking mechanisms may not provide certain secondary safety considerations, such as manual unlocking during malfunction or providing an alternative method of disengagement when accidentally deployed, which may have secondary concerns in other emergency situations, such as when the lock is inadvertently deployed or activated when the building and/or room is intended to be evacuated, like in the case of a fire.

These existing electronic lock systems that incorporate remote features are typically designed for access control in commercial or residential environments and not for high-stress, high-risk scenarios such as school lockdowns or active shooter events. These systems frequently require power and network infrastructure that may be compromised during emergencies. Furthermore, they are rarely designed to prioritize occupant safety in facilitating both rapid lockdown and subsequent controlled egress. Furthermore, malfunction or inadvertent locking of these electronic door locks can result in unsafe situations in the case of emergency evacuation, which can trap occupants inside an unsafe or deadly environment.

Accordingly, there remains a need for a robust, emergency-deployable secondary lock that can be rapidly activated, remotely or manually, in the event of a security threat. Such a system may offer battery-powered autonomy, provide visible confirmation of lock status to both interior and exterior observers, and integrate surveillance capabilities to enhance situational monitoring during a crisis. The instant disclosure may be designed to address at least certain aspects of the problems or needs discussed above by providing such a device and method of use.

### SUMMARY OF THE DISCLOSURE

The present disclosure relates to an improved emergency-deployable secondary door lock system with external status indication and method of use. The lock system comprises several key components designed to optimize functionality during emergency situations for both building/room occupants and emergency responding personnel, as well as preventing inadvertent emergency activation from endangering occupants of a building or room.

In an exemplary embodiment, described herein is an emergency-deployable secondary door lock system that addresses the shortcomings of conventional and previously proposed supplemental locking solutions. The system is designed for rapid deployment during high-stress emergency events, such as active shooter incidents inside schools, where immediate and reliable door reinforcement can be essential to protecting occupants within a room or other secured space. The system may include a locking mechanism that is mounted to a door and engages with a frame-mounted strike receiver. A servo-actuated latch may permit a remote locking and/or unlocking through a handheld wireless fob, while a manual thumb turn allows users to engage or release the lock from inside the room as necessary. The lock may be primarily powered by a dedicated battery supply to ensure independence from building power or network connectivity during crises.

In some embodiments, a highly visible status light, coupled via a shank through the door structure, may indicate the current state of the lock: for instance, a steady green light may confirm successful engagement, while a flashing red light may signal entry by an intruder or some other danger. In such embodiments, an integrated interior-facing camera may provide real-time video monitoring of the protected space, which may be accessible through a network-connected application or secured interface. This allows for enhanced situational awareness and informed decision-making by security personnel or first responders. Additionally, this may allow for such personnel the ability to easily traverse extensive hallway systems and “clear” areas of the school for either evacuation or to relieve them of a threat status. Certain additional variations of this embodiment may enable the ability to center upon or locate the danger and/or threats within the building such that focus can be made upon dealing with and extinguishing the emergency and/or threat through either countermeasures, containment, or the like.

While the disclosed system and method of use may be integrated into new installations via door assemblies, it may be primarily designed for retrofit installation on existing door assemblies, allowing schools and other facilities to enhance security without the need for complete door replacement or major structural modifications. The system can be mounted using common fasteners and aligns with standard door, frame, and jamb geometries, making it suitable for widespread implementation across different building types and ages. Power can be supplied by an internal battery pack, which can be charged at regular intervals (e.g., overnight monthly), eliminating the need for hardwired electrical connections and further simplifying installation. The wireless receiver and control unit may communicate using standard protocols, thus enabling compatibility with existing access control and emergency response platforms. In particular, the system can be integrated into various currently available school-wide SaaS- or other software-based security platforms as well as other building security and/or monitoring systems, which can allow administrators to remotely monitor the status of each lock, manage charging needs, activate or deactivate locks in specific zones, and receive alerts when a lock is engaged. In embodiments where an integrated camera provides live video feeds that can be streamed to centralized monitoring dashboards, real-time threat assessment and coordination with first responders can be better accomplished and managed. The status light signals and/or locking sensor status can also be tied into automated alert systems, ensuring that visual indicators are synchronized with school-wide lockdown or evacuation protocols. The modular design can support phased implementation, allowing institutions to prioritize high-risk areas first and expand coverage over time. This scalable approach makes the system ideal for schools and other buildings seeking to enhance security using existing infrastructure and centralized digital tools.

Importantly, the inclusion of a manual release mechanism can ensure that occupants are not inadvertently trapped in the event of a false activation, malfunction, or secondary emergency such as a fire. In such cases, the thumb turn may allow for rapid, intuitive disengagement of the lock, enabling safe egress without requiring electrical or remote control. The inclusion of a manual thumb turn can also ensure compliance with fire safety codes by allowing occupants to unlock the door from the inside without the use of keys, tools, or specialized knowledge. This feature preserves emergency egress routes even when the lock is engaged and since it can only be accessed from the interior, does not interfere with the primary function of barring intruder entry. Additional safety features, such as remote release via, e.g., an encrypted and/or specialized signal only available to building personnel and/or emergency responders can further improve upon these aspects.

By combining physical security, remote actuation, local manual override, visual feedback, and surveillance capabilities, the disclosed system offers a comprehensive solution for emergency preparedness. It is especially suited for installation in classrooms, offices, and other vulnerable public-facing environments, where it can serve as a vital layer of defense during hostile intrusions or other emergent threats.

Then, it may be realized by those having ordinary skill in the art, upon a review of the below Detailed Description in combination with the Drawings, that such an emergency-deployable secondary door lock system with external status indication and method of use as may be disclosed herein represents a significant advancement in building security compared to existing standard primary locks as well as enhanced primary locking mechanisms and even security-minded and smart locking systems, such as those described above. By enabling both electronic and manual locking and release, providing a status indicator to both those inside and outside the room, and, in certain embodiments, enabling interior views via a network- or radio-based camera, the disclosure seeks to both improve security while ensuring safe and reliable room and/or building egress remains compliant with fire and safety codes.

The foregoing illustrative summary, as well as other exemplary objectives and/or advantages of the disclosure, and the manner in which the same are accomplished, are further explained within the following Detailed Description and its accompanying Drawings.

### BRIEF DESCRIPTION OF THE DRAWINGS

The present disclosure will be better understood by reading the Detailed Description with reference to the accompanying drawings, which are not necessarily drawn to scale, and in which like reference numerals denote similar structure and refer to like elements throughout, and in which:

FIG. 1 is a perspective room interior drawing of an exemplary embodiment of locking system of the disclosure installed and locked on a closed door;

FIG. 2 is a perspective drawing of the same with the door ajar and locking system in the unlatched positioned with an enlarged view thereof;

FIG. 3 is a perspective exterior room drawing of the locked closed door with an enlarged view thereof;

FIG. 4 is a series of perspective drawings of the locking system in various positions, one being a cutaway to expose interior components;

FIG. 5 is a series of elevation partial-cutaway drawings of the locking system alongside perspective drawings of the servo and remote of the disclosure;

FIG. 6 is a block diagram of some of the components of the locking system; and

FIG. 7 is a flowchart of an exemplary method of the disclosure.

It is to be noted that the drawings presented are intended solely for the purpose of illustration and that they are, therefore, neither desired nor intended to limit the disclosure to any or all of the exact details of construction shown, except insofar as they may be deemed essential to the claimed disclosure.

### DETAILED DESCRIPTION

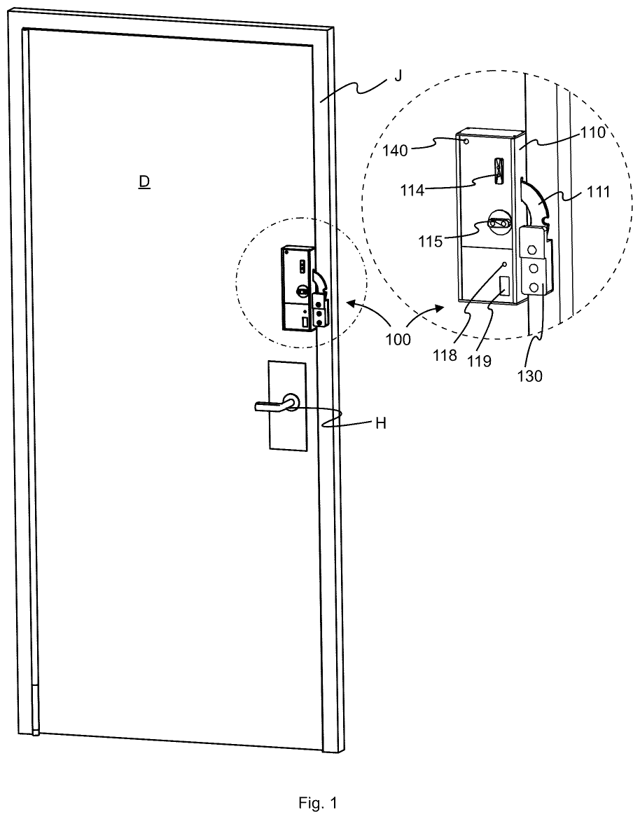

In describing the exemplary embodiments of the present disclosure, as illustrated in FIGS. 1-7, specific terminology is employed for the sake of clarity. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples, and are merely examples among other possible examples. As used herein, “door” and “entry” may be used interchangeably, and references to a “frame” or “jamb” may be interchangeable and include any structure, frame, or wall portion against which a door may be secured. The word “lock” is intended to encompass any mechanical, electromechanical, or electronic device configured to prevent or restrict passage through an entryway. References to “remote” or “remote control” may include wireless handheld devices, key fobs, or any transceiver-equipped interface capable of communicating lock control signals. The terms “camera” and “surveillance unit” may be used interchangeably and include image-capturing devices that are mounted to or integrated within the locking system and directed toward the interior of a room. As used herein, “status light” or “indicator light” may refer to one or more visual output devices configured to signal the lock's status to an observer, including but not limited to color-coded or blinking light patterns. Additionally, with respect to positioning of the emergency-deployable secondary door lock system with external status indication, an exemplary position has been provided herein, but other positions include but are not limited to the upper edge of the door, a lower portion of the door on the strike side, upon the frame adjacent the jamb on either the top edge, or as a stop installed and configured upon a hinge. Additionally, the mechanisms as described herein as locking mechanism 110 may be installed upon the door as herein described or may be installed upon frame J, as may be understood by those having ordinary skill in the art. While a vertical orientation of various aspects of the disclosure may be preferred, such as for locking mechanism 110, strike receiver 130, and/or exterior indicator light assembly 141, horizontal and/or angles therebetween may be substituted as may be understood by those having ordinary skill in the art. As will be described in greater detail below, the disclosed locking system may be installed as a secondary security measure and is particularly configured for rapid deployment during emergency scenarios requiring delayed or prevented access into a secured room or area, though it may also be used in situations where no primary locking mechanism is present.

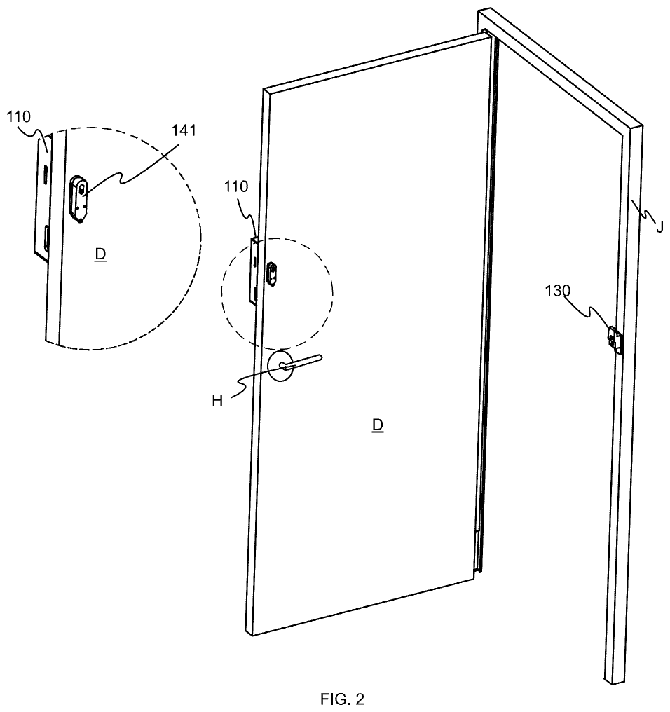

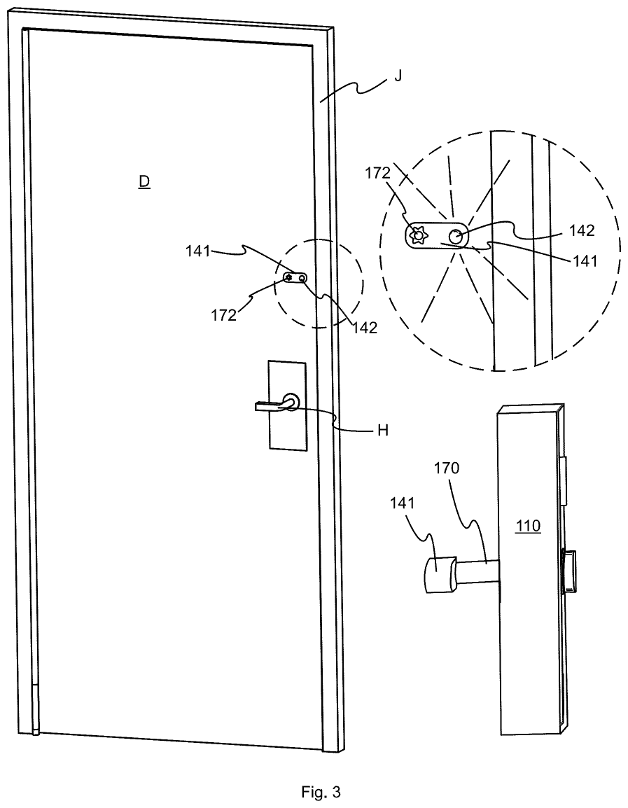

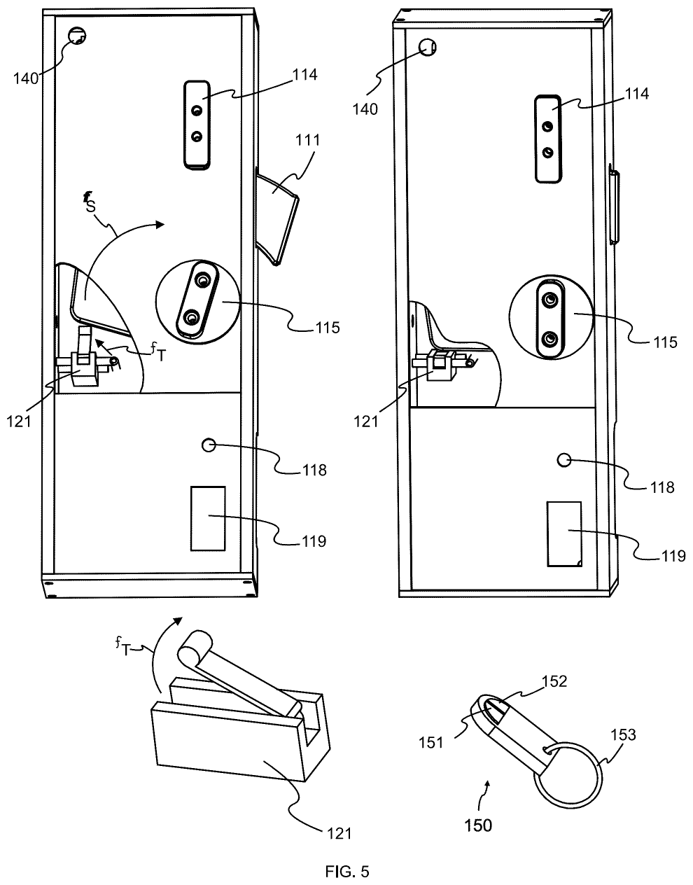

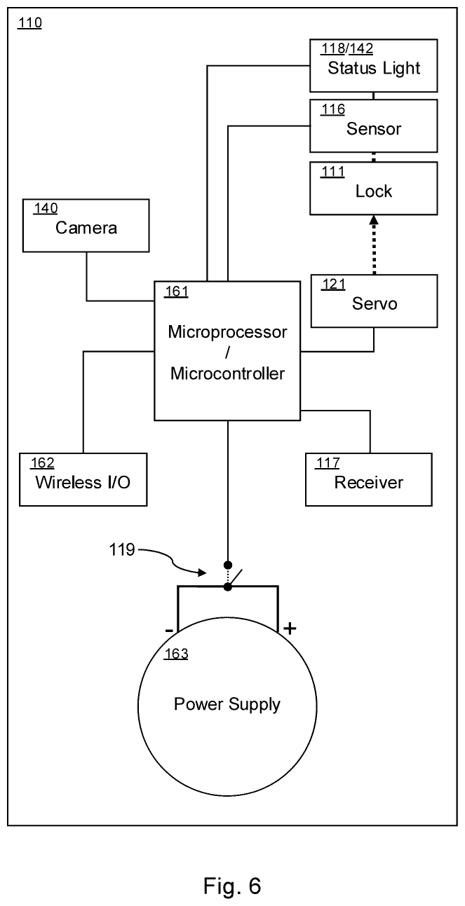

Referring now first specifically to FIG. 1, emergency-deployable secondary door lock system 100 of the disclosure is illustrated therein as it may be preferably installed upon door D and engaged to lock upon frame J. As described above, such a system may be adapted to provide supplemental locking functionality and visual feedback for emergency and security scenarios. Emergency-deployable secondary door lock system 100 may primarily include locking mechanism 110 and strike receiver 130. Locking mechanism 110 preferably includes a turning latch 111 operable via a thumb turn 115 or electronically actuated using servo 121 (see FIG. 5). Turning latch 111 interfaces with strike receiver 130, which may be preferably mounted on door frame J to secure door D in a closed and locked position. A manual release 114 may be engaged to override or disengage the locking mechanism under appropriate conditions, or alternatively and potentially preferably may be installed to quickly engage turning latch 111 into the locked position with strike receiver 130 via a latch and spring mechanism to enable turning of turning latch 111 when release 114 is lifted. Such a preferable operation of release 114 may enable quick engagement of turning latch 111 to strike receiver 130, i.e., a locking position, when any of the following are true: emergency-deployable secondary door lock system 100 lacks sufficient electronification to deploy, an operator is not in possession of remote 150, remote 150 lacks sufficient electronification and/or communication with receiver 117, or an operator is incapacitated and another individual wishes to engage emergency-deployable secondary door lock system 100 to lock door D. As illustrated herein FIG. 1, emergency-deployable secondary door lock system 100 may also incorporate an interior indicator light 118 and an exterior indicator light assembly 141, 142 (see FIGS. 2-3), each of which may provide visual feedback of the lock status to those interior and exterior door D, respectively. Interior switch 119 may permit a local user power control of the locking mechanism, such as for arming emergency-deployable secondary door lock system 100, preferably during the start of a day and disarming after a day has concluded, to preserve battery in those units as disclosed herein which feature primary and/or secondary battery power. As also illustrated herein FIG. 1, interior camera 140 may be mounted within emergency-deployable secondary door lock system 100 and configured to capture and/or broadcast video footage of the interior environment. Interior camera 140 may interface with microprocessor/controller 161 (see FIG. 6), which may govern the overall operation of emergency-deployable secondary door lock system 100. Then, with regard to manual operation of emergency-deployable secondary door lock system 100, an operator is given at least two options to engage turning latch 111 via turning latch 111 by turning thumb turn 115 (in this installation in a clockwise direction) or by alternatively lifting release 114. To disengage, an operator may turn thumb turn 115 (anti-clockwise). Remote and/or electronic variations of engagement and/or disengagement of emergency-deployable secondary door lock system 100 are described in relation to the remaining Drawings. As described above, emergency-deployable secondary door lock system 100 may be particularly suited for educational or institutional facilities where visual lock status, rapid emergency deployment, and remote engagement are critical to safety protocols as well as preventing ingress via an entry and/or enabling the same, depending on the situation and/or any development(s) thereof.

Turning now to FIG. 2, illustrated therein is a perspective view of emergency-deployable secondary door lock system 100 installed on representative door D and jamb or frame J, with enlarged detail views of components located on the interior face of the door. Locking mechanism 110 is illustrated mounted to door D and configured to engage with a corresponding strike receiver 130 affixed to frame J. Locking mechanism 110 may include or be operatively connected to a turning latch (not shown in this view), which extends laterally toward and into strike receiver 130 to secure the door in a locked position when the system is activated. Handle H is shown on the door D, which may be an existing part of the door assembly and not necessarily integral to locking system 100 of the disclosure. Adjacent to locking mechanism 110, exterior indicator light 141 may be mounted through the door via a shank installation and may be configured to be visible from outside a room. Indicator light 141 may emit a color-coded and/or pulsed light patterns to signal whether emergency-deployable secondary door lock system 100 is engaged, disengaged, or recently activated under emergency conditions, such as when an intruder is present in the room or to signal some other distress present in the room (e.g., an injury or other emergent scenario). An enlarged inset view provides additional detail regarding the placement and orientation of locking mechanism 110 and indicator light 141 on door D, illustrating how the components may be mounted in close proximity. Strike receiver 130 mounted to frame J may be positioned such that it aligns with and receives turning latch 111 of locking mechanism 110 when the door is in a closed position. The arrangement shown in FIG. 2 allows the lock system to be installed as a secondary mechanism, independently of door handle H, to provide enhanced security during emergencies, or to serve as a primary lock in installations currently lacking a primary lock.

Turning now to FIG. 3, illustrated therein is a front exterior perspective view of door D equipped with emergency-deployable secondary door lock system 100, with enlarged detail views of exterior indicator light assembly 141 assembly components mounted through the door. Handle H is shown on door D and may again represent an existing component of a conventional door assembly. Exterior indicator light assembly 141 may be visible on the outer face of door D and may be installed to project light outward from within the room to the hallway or exterior environment. Indicator light 141 may be coupled through the door and mounted via shank, fastener, or interference fit. As seen in the enlarged detail view, indicator light 141 may be configured with a visible lens cap or emitter surface and may include, or be positioned adjacent to, exterior-facing exterior indicator light 142. Indicator light 142 may be operatively connected to one or more controllers or sensors within emergency-deployable secondary door lock system 100 to visually signal status of the locking mechanism. For example, indicator light 142 may emit a steady green light to indicate that the lock is successfully engaged or a flashing red light to indicate emergency deployment. Frame J is shown surrounding door D and may correspond to an existing frame structure of a school, office, or public facility door. The arrangement depicted in FIG. 3 allows emergency-deployable secondary door lock system 100 to provide real-time status indication to those outside the room, which may assist in emergency response, occupant protection, and general situational awareness. In the additional detail view shown at the bottom right, exterior indicator light assembly 141 is illustrated with the door removed to show the full assembly (locking mechanism 110, conduit 170, and exterior indicator light assembly 141) from its side, revealing the connections of exterior indicator light assembly 141 to locking mechanism 110 via conduit 170. Conduit 170 may house at least one electrical lead and/or signaling wire for indicator light 142, and in various preferred embodiments, may also contain a mechanical actuator and/or cam interface configured to engage a locking pin 171. Locking pin 171 may be positioned within locking mechanism 110 and mechanically coupled to turning latch 111, such that axial or rotational movement of locking pin 171 results in rotation or release of turning latch 111. Exterior indicator light assembly 141 may be removably fastened to the outer surface of door D via, e.g., security screw 172, which may be selected from a tamper-resistant screw type operable only with a specialized bit or tool issued to or accessible by law enforcement or emergency personnel. Upon removal of security screw 172, exterior indicator light assembly 141 may be rotated or twisted manually to rotate locking pin 171 and mechanically disengage turning latch 111 from strike receiver 130. This emergency override configuration may provide an important fail-safe function, enabling first responders to gain access to a locked room in the event of electronic failure, lost credentials, or immediate danger to occupants. In such embodiments, the actuation of locking pin 171 by exterior indicator light assembly 141 may bypass or supplement normal servo or thumb turn operations.

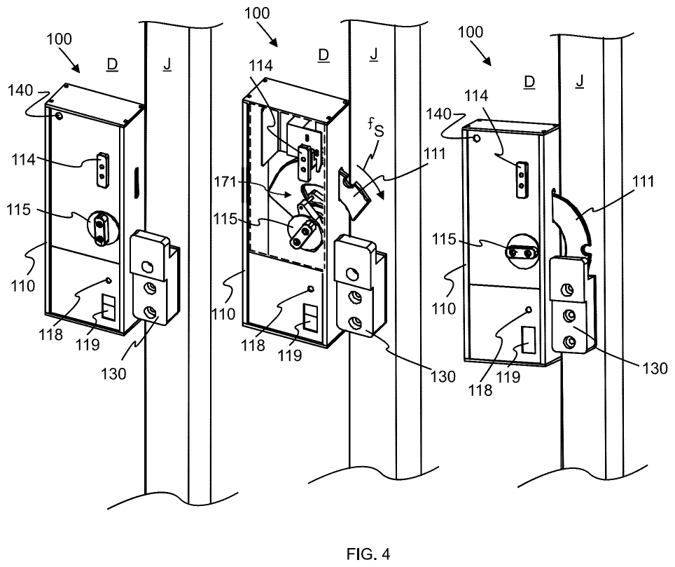

Turning now to FIG. 4, illustrated therein are three sequential views of emergency-deployable secondary door lock system 100, the central of which shows a cutaway of a portion of the casing thereof, each showing progressive positions of internal components during activation and engagement of turning latch 111. As described above, locking mechanism 110 may be mounted to interior surface of door D and configured to engage strike receiver 130 mounted to frame J. In each view, locking mechanism 110 includes thumb turn 115 operatively connected to turning latch 111 and release 114. Moving from left to right, turning latch 111 is not visible in the first illustrated state of emergency-deployable secondary door lock system 100, corresponding to an unengaged or at-rest condition of locking mechanism 110, though it may be switched on via switch 119 (or not) and in an armed (or unarmed) state. Interior indicator light 118 and switch 119 are also shown, mounted toward the lower portion of locking mechanism 110 and accessible to a user within the secured room. Camera 140 is shown mounted on the upper portion of locking mechanism 110, directed inward to monitor the interior of the room. Turning to the center illustration, a cutaway view reveals internal interaction between thumb turn 115, release 114, and turning latch 111 as locking mechanism 110 transitions toward engagement. Swinging force fS is represented as a potential breach direction applied against door D during a forced intrusion attempt. Turning latch 111 is rotated into position to extend toward strike receiver 130. Also visible in this center partial cutaway view is locking pin 171, which may be disposed within locking mechanism 110 and operably connected to turning latch 111. Locking pin 171 may be configured to rotate or shift under mechanical input, such as that received from exterior indicator light assembly 141 via conduit 170, as described above with reference to FIG. 3. In such configurations, rotation of exterior indicator light assembly 141, once, e.g., security screw 172, has been removed, may mechanically actuate locking pin 171 to release or rotate turning latch 111 from the locked position, enabling access during an emergency override. This type of mechanical override may be particularly important or even critical for use of secondary locking mechanisms with regard to satisfying fire safety codes and emergency egress requirements, thus enabling law enforcement and/or emergency responders to gain access during crises such as fires and/or medical emergencies. The specific configuration of security screw 172 may be selected based on local jurisdictional requirements, as may be well understood by those skilled in the art, and the known capabilities and/or tooling available to authorized personnel, ensuring both access control and compliance with lifesaving egress protocols and regulations. In the rightmost illustration, turning latch 111 is fully extended and received within strike receiver 130, securing door D in the locked position. As may be appreciated by those having ordinary skill in the art, the progression illustrated in FIG. 4 demonstrates how turning latch 111 may be selectively rotated into strike receiver 130 by either manual actuation of thumb turn 115 or servo-assisted actuation described elsewhere herein (see FIGS. 5-6). The enclosed configuration of locking mechanism 110 protects internal components from tampering and allows for surface-mount retrofit on existing doors. Emergency-deployable secondary door lock system 100 as shown enables intuitive manual operation and status indication while providing secure physical engagement during high-stress emergency scenarios, while enabling disengagement manually when emergency-deployable secondary door lock system 100 either fails to function and/or egress is desired due to unsafe conditions within a room being locked by emergency-deployable secondary door lock system 100.

Turning now to FIG. 5, illustrated therein are multiple views of emergency-deployable secondary door lock system 100 and components thereof, including details relating to actuator functionality and remote engagement via remote 150. In the upper left view, turning latch 111 is shown extended from locking mechanism 110 in the engaged position, corresponding to a locked state of door D. Thumb turn 115 is shown centrally mounted to the internal face of locking mechanism 110 and may be manually rotated to actuate or release turning latch 111. Servo 121 may be mounted adjacent to turning latch 111 and may apply activation force fT to initiate rotation of turning latch 111 toward strike receiver 130 (not shown in this view, see FIGS. 1-4). Swinging force fS is shown as a representative direction of force that may be applied against the door during an attempted intrusion, resisted by engagement between turning latch 111 and strike receiver 130. Camera 140 is shown in each upper view as mounted to locking mechanism 110, with a field of view directed inward to monitor the secured space. Interior indicator light 118 and switch 119 are also shown mounted to the lower portion of locking mechanism 110, accessible from within the room. Servo 121 may be electronically controlled by an onboard microcontroller and actuated in response to wireless input signals, local switch 119 activation, or remote-control input via remote 150. In the lower left detail view, servo 121 is illustrated in isolation, with an actuation arm shown applying activation force fT to a connected drive shaft and/or cam mechanism. In the lower right view, remote control 150 is shown, including actuatable buttons 151 and 152, which may correspond to lock and unlock functions, respectively. Remote attachment 153 may be included for tethering or keyring integration. Wireless signal from remote control 150 may be received by a radio receiver component of system 100 and used to trigger actuation of servo 121. The features illustrated in FIG. 5 enable selective, remote-initiated locking and unlocking of emergency-deployable secondary door lock system 100, while preserving full manual override capability through thumb turn 115.

Then, in certain preferred embodiments of emergency-deployable secondary door lock system 100 where simplification of mechanisms might be achieved to provide an efficient and cost-effective means for accomplishing the aims of the disclosure, certain additional considerations might be made. For example, turning latch 111 may be spring-loaded such that rotation of thumb turn 115 in an anti-clockwise direction moves turning latch 111 into a retracted or disengaged position and engages a notch or catch mechanism to hold turning latch 111 in that unlocked position. In such a configuration, turning latch 111 may be said to be “armed” and/or “ready” to engage, but in the open or non-engaged position. Upon actuation of release 114, whether manually or through servo 121 assisted means, the notch is disengaged, and the stored energy of the spring causes turning latch 111 and thumb turn 115 to rotate clockwise, thereby causing turning latch 111 to extend into strike receiver 130 and secure door D. This arrangement may reduce reliance on continuous electronic actuation and allow for mechanical triggering of the lock engagement, while still maintaining compatibility with visual indicators and remote signaling components described herein. This spring-loaded configuration may further simplify the function of servo 121 by requiring only a short actuation to trip release 114, rather than having to exert rotational torque to fully move turning latch 111 into engagement. As such, servo 121 may be of smaller size, consume less power, and require less mechanical complexity. However, one drawback of such a configuration may be that the unlocking operation (i.e., the retraction of turning latch 111) cannot be performed remotely using remote 150. Instead, a user would be required to manually turn thumb turn 115 in the anti-clockwise direction to return system 100 to its armed or disengaged state. In other embodiments which may enable both locking and unlocking via remote 150, such alternative embodiments may include a bidirectional servo 121 capable of applying torque in both clockwise and anti-clockwise directions, thereby permitting full remote control of turning latch 111 movement. In some versions, turning latch 111 may be mounted on a cam or gear assembly responsive to motor-driven rotation, wherein servo 121 is electronically reversible. Alternatively, dual-solenoid systems or electromechanical clutch assemblies may be implemented to selectively engage locking or unlocking paths depending on the command received from remote 150 or switch 119. These configurations may provide greater versatility and user convenience but may require higher power draw, more complex control logic, increased cost of manufacture, and/or more complicated measures to unlock emergency-deployable secondary door lock system 100. As with many of the examples disclosed herein, the choice between mechanical simplicity and electronic versatility may be determined based on the particular installation context and level of user interaction desired. With respect to certain lighting features of various embodiments of emergency-deployable secondary door lock system 100, indicator light 141 may be illuminated in response to the physical position of turning latch 111, as detected by a sensor (e.g., sensor 116—see FIG. 6) disposed within locking mechanism 110. Sensor 116 may comprise a limit switch, magnetic reed switch, or optical proximity sensor configured to detect when turning latch 111 is fully engaged or retracted. Alternatively, indicator light 141 may be activated by completing an electrical circuit upon engagement of switch 119 or by receiving a signal from e.g., microcontroller 161 (see FIG. 6) in response to actuation of servo 121. Additionally, as discussed above, in some embodiments, different light colors or pulsing patterns may correspond to different detected states, such as engaged, disengaged, or emergency-triggered conditions, as may be relevant to those having ordinary skill in the art or as may be preferable to various state and/or regulatory concerns. As may be understood by those having ordinary skill in the art, certain alternative embodiments, emergency-deployable secondary door lock system 100 may be configured in a reversed or “flipped” orientation, wherein locking mechanism 110 is mounted to frame J and strike receiver 130 is mounted to door D. In such configurations, turning latch 111 may extend outward from the jamb toward the door, engaging strike receiver 130 when the door is closed. This orientation may be advantageous in installations where space constraints or door material considerations favor mounting the active locking components to the stationary frame rather than the moving door. In some versions of this flipped configuration, locking mechanism 110 may receive continuous power from a building power supply, such as via a wired connection to an outlet, low-voltage transformer, or hardwired circuit, thereby eliminating the need for battery management.

Turning now to FIG. 6, illustrated therein is a schematic block diagram of electrical and logical components that may be incorporated into an exemplary locking mechanism 110 of emergency-deployable secondary door lock system 100. Locking mechanism 110 may include a microprocessor or microcontroller 161 configured to manage electrical signaling, component control, and system logic. Power to microcontroller 161 and associated components may be supplied by power supply 163, which may comprise one or more batteries housed within locking mechanism 110 or may receive power from an electrical supply installed permanently thereon in certain embodiments. Activation or arming of emergency-deployable secondary door lock system 100 may occur upon closure of switch 119, which completes the circuit between power supply 163 and microcontroller 161. Microcontroller 161 may be operatively connected to camera 140, which may be positioned to capture images or video of an interior space adjacent to the secured side of door D. Wireless input/output module 162 and receiver 117 may enable wireless communication with remote 150 or other networked control systems, such as those in communication with video download/streaming/broadcasting services and/or externally networked computing devices or such as those indicating locking status to security installations for the building and/or room, facilitating command receipt and status updates as well as video in certain preferred embodiments. Microcontroller 161 may also be connected to servo 121, which, upon receiving a signal, may actuate turning latch 111 to engage or disengage strike receiver 130, as described in previous Drawings. Sensor 116 may be positioned to detect the physical state of turning latch 111 or other internal locking components, and may provide status feedback to microcontroller 161 or may be a function of a circuit closing in an armed state as disclosed above. Based on the signal received from sensor 116, microcontroller 161 may illuminate status light 118 and/or 142 to indicate lock status. For example, a green light may confirm lock engagement, while a red blinking light may indicate emergency deployment. In this configuration, indicator lights may be triggered based on component position, switch actuation, or other circuit-based conditions, allowing for visual communication of system status to observers both inside and outside the secured room. In certain alternative and perhaps preferred embodiments of the electrical schema as illustrated in FIG. 6, the electrical layout of emergency-deployable secondary door lock system 100 may be configured such that activation of camera 140 and status lights 118 and/or 142 is directly tied to the release of switch 119, which in turn corresponds to release of the locking mechanism. In such embodiments, pressing a momentary button on remote 150 or manually actuating release 114 may cause switch 119 to open or close (depending on circuit configuration), completing an electrical circuit powered by power supply 163. This change in switch state may serve as a trigger event for microcontroller 161, which may then send activation signals to servo 121, status light 118, and camera 140. Importantly, in such an embodiment, turning latch 111 may be released or driven into engagement as part of this same sequence, such that the physical locking action is electronically synchronized with visual and recording elements. Although the specific routes of internal wiring are not shown in detail in FIG. 6, it will be understood that such wiring may be configured to allow for efficient integration of switch-based triggers, direct circuit completions, and microcontroller coordination. The physical layout of these components within locking mechanism 110 may be optimized to minimize response time, power loss, and electromagnetic interference, ensuring reliable activation of security features upon command input or manual override. In various embodiments, system 100 may be configured to operate on rechargeable batteries housed within locking mechanism 110, primary batteries housed therein, and with the unit designed to be removably mounted to allow for periodic recharging or via exchangeable modular batteries. For example, the entire unit may be detached and recharged at a docking station, or batteries may be removed and exchanged and/or recharged separately from the installed housing. These flexible power configurations permit system 100 to be adapted for a variety of use cases, including permanent installations in commercial buildings as well as temporary or portable applications in field-deployed environments.

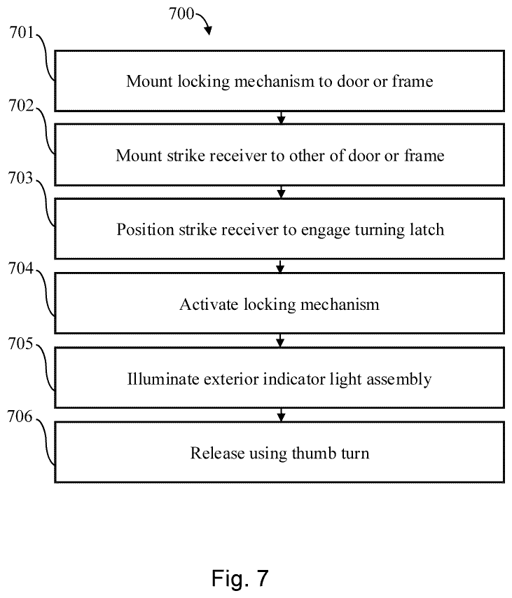

Turning finally to FIG. 7, illustrated therein is method flowchart 700 depicting an exemplary sequence of steps for securing a door to a frame using emergency-deployable secondary door lock system 100. At step 701, emergency-deployable secondary door lock system 100 is mounted to at least one of door D or the frame J. This locking mechanism may include components such as turning latch 111, thumb turn 115, servo 121, microcontroller 161, receiver 117, power supply 163, and optionally, camera 140 and indicator light 118, as may be discussed in greater detail above. At step 702, strike receiver 130 is mounted to the other of door D or the frame J (i.e., whichever surface does not receive locking mechanism 110). In step 703, strike receiver 130 is positioned such that it aligns with and receives turning latch 111 when the door is in a closed position. This positional alignment ensures mechanical engagement during emergency-deployable secondary door lock system 100 activation. At step 704, locking mechanism 110 is activated. Activation may be achieved via manual release 114 or wirelessly through remote control 150, which transmits a signal to receiver 117, prompting microcontroller 161 to engage servo 121 and rotate turning latch 111 into strike receiver 130. At step 705, the exterior indicator light assembly (e.g., 141, 142) is illuminated to visibly communicate the locked status to observers outside the room. As discussed in greater detail above, exterior indicator light 142 may emit different colors or patterns depending on system state, as governed by microcontroller 161 and potentially informed by sensor 116. At step 706, the system may be manually released using thumb turn 115. This step may be performed during routine disengagement or emergency egress, ensuring compliance with fire safety and building egress codes. While FIG. 7 depicts a simplified operational method, various other features and mechanisms are disclosed elsewhere in the Drawings and description related thereto. For example, camera 140 (see FIGS. 4-6) may provide live interior monitoring of the secured room and may be activated during or after locking to transmit real-time video to security personnel or centralized monitoring systems. Additionally, microcontroller 161 (see FIG. 6) may manage logical operations and coordinate signals from receiver 117, sensor 116, servo 121, and other electronic and/or mechanical components. It may also interface with wireless I/O module 162 for integration into third-party security platforms. Spring-loaded turning latch configurations can also allow locking mechanism 110 to be “armed” manually and deployed rapidly via mechanical or servo-triggered release, reducing power consumption and simplifying components, as described above. Status light 118/142, which may be internally or externally visible (see FIGS. 2-3, 5-6), may be capable of conveying system state through steady or flashing light patterns and multiple colors. Power supply 163 may comprise either a rechargeable battery or a hardwired connection, with optional removable or modular configurations for recharging as described above. Additionally, a bidirectional version of servo 121 and corresponding software logic may allow the same mechanism to both engage and disengage turning latch 111, which may be electronically-useful in fully remote-operated systems. A shank or conduit (see FIGS. 2-3 and 6 and relevant description related thereto) extending from locking mechanism 110 to the exterior-facing surface of either door D or frame J may enable electrical and visual elements to be externally presented while remaining secure and tamper-resistant. Remote control 150 (see FIG. 5) may include user-actuatable buttons 151 and 152 for sending commands to engage or release the lock, with attachment 153 providing physical retention on a keyring or belt. Sensor 116 (see FIG. 6) may be used to detect latch position or tampering attempts, providing feedback to microcontroller 161 for updating system status and triggering alerts. These and other configurations described in the detailed description, claims, and figures support both secure emergency deployment and intuitive manual override, making the disclosed system suitable for schools, offices, and other high-risk environments, as may be relevant to method 700.

With respect to the above description, it is to be realized that any and all optimal shape(s), mechanism(s), configuration(s), modular installation method(s), system(s), step(s), user interface(s), features, data, position(s), function(s), and manner of operation and use are intended to be encompassed by the present disclosure. Preferably, the disclosed system may include standard hardware, building fixtures and components, and software components in addition to new components as may be disclosed herein. Building perspective drawings, computer-assisted designs, and other schematics are provided for exemplary purposes only. The layout, function, colors, and other features of emergency-deployable secondary door lock system 100 as may be disclosed herein may vary and are not intended to limit the disclosure. Parts lists and steps of various methods provided in numbered lists or flow charts are provided to illustrate what the inventor perceives to be the best mode of accomplishing the specified functions and/or tasks, and do not limit the disclosure. As discussed above, the disclosure is not limited to uses in school settings and may be broadly applicable to other installations, buildings, dwellings, vehicles, aircraft, marine vessels, and the like, or combinations thereof, and may be applicable to any location where an active shooter may present themselves or other threatening situations may occur that require a lockdown of a location in order to ensure the safety of those therein, such as in a room or behind an entry and/or passage.

It is further contemplated herein that additions and/or deletions could be made to the system of the disclosure to further increase the capabilities of the system of the disclosure and/or to limit the capabilities of a user if so desired. By way of example and not limitation, emergency-deployable secondary door lock system 100 of the disclosure could be enhanced to increase visibility of the lighting features disclosed herein, such as by incorporating a laser, or may be augmented to include the dimming of hallway lighting such that the illuminating features of the disclosure are better visible. Emergency-deployable secondary door lock system 100 of the disclosure may operate on its own or may integrate into various known or yet-to-be-developed systems for building security and monitoring, as may be understood by those having ordinary skill in the art. Emergency-deployable secondary door lock system 100 may interact with proprietary and/or third-party systems and devices, including but not limited to IoT devices (e.g., smart locks, key boxes, thermostats, lights, fans, home audio, security systems, cameras, and the like), government alert systems, background check directories, or combinations thereof. Notably, the various lighting features as herein described, including but not limited to exterior indicator light assembly 141, emergency-deployable secondary door lock system 100, as well as their methods of use, and other features of the disclosure may be retrofitted into existing locking and/or security systems in alternate embodiments of the disclosure.

The foregoing description and Drawings comprise illustrative embodiments of the present disclosure. Having thus described exemplary embodiments, it should be noted by those of ordinary skill in the art that the within disclosures are exemplary only, and that various other alternatives, adaptations, and modifications may be made within the scope of the present disclosure.

Merely listing or numbering the steps of a method in a certain order does not constitute any limitation on the order of the steps of that method. Many modifications and other embodiments of the disclosure will come to mind to one of ordinary skill in the art to which this disclosure pertains, having the benefit of the teachings presented in the foregoing descriptions and the associated drawings. Although specific terms may be employed herein, they are used in a generic and descriptive sense only and not for the purposes of limitation. Moreover, although the present disclosure has been described in detail, it should be understood that various changes, substitutions, and alterations can be made thereto without departing from the spirit and scope of the disclosure as defined by the appended claims. Accordingly, the present disclosure is not limited to the specific embodiments illustrated herein, but is limited only by the following claims.

1. A door security system configured to secure a door to a frame, the system comprising:
a locking mechanism configured to be mounted to an at least one of the door and the frame, said locking mechanism comprising:
a turning latch disposed within said locking mechanism and rotatable between an unlocked position and a locked position;
a thumb turn mechanically coupled to said turning latch and operable to rotate said turning latch between said locked position and said unlocked position;
a release mechanism and a servo configured to trigger a rotation of said turning latch from said unlocked position to said locked position;
a microcontroller operatively connected to said servo and configured to transmit an electronic control signal to the servo upon receiving an activation input, said electronic control signal causing said servo to trigger said rotation;
a wireless receiver operatively connected to said microcontroller and configured to receive a signal from a remote control; and
a power supply configured to supply electrical power;
a strike receiver configured to be mounted to at least the other of said at least one of the door and the frame and positioned to receive said turning latch of the locking mechanism when the door is in a closed position;
a conduit extending from said locking mechanism extending to an exterior-facing surface of said at least one of the door and the frame, said conduit housing at least a connection between said microcontroller and a status light; and
said status light visible on said exterior-facing surface of said at least one of the door and the frame and configured to indicate a state of said locking mechanism.

2. The door security system of claim 1, wherein said status light is configured to emit a first color when said turning latch is in said locked position and a second color when said turning latch is in said unlocked position.

3. The door security system of claim 1, further comprising a sensor operatively connected to said microcontroller and configured to detect a position of said turning latch and transmit a corresponding signal to said microcontroller.

4. The door security system of claim 1, wherein said release mechanism comprises a spring-loaded catch configured to retain said turning latch in said unlocked position, and wherein actuation of said release mechanism causes said turning latch to rotate to said locked position under a stored spring force.

5. The door security system of claim 1, wherein said servo is a bidirectional servo configured to rotate said turning latch from said locked position to said unlocked position and from said unlocked position to said locked position in response to commands from said microcontroller.

6. The door security system of claim 1, further comprising a camera mounted to said locking mechanism and oriented to capture video of an interior-facing space adjacent to said door.

7. The door security system of claim 1, wherein said power supply comprises a rechargeable battery removably mounted within said locking mechanism.

8. The door security system of claim 7, wherein said locking mechanism is configured to be removably detached from said at least one of the door and the frame for recharging said battery.

9. The door security system of claim 1, further comprising a security screw fastening said status light to said other of said at least the door and the frame, wherein said conduit is operably coupled to said turning latch and a release of said security screw additionally enables said rotation between said locked position and said unlocked position.

10. The door security system of claim 6, wherein said microcontroller is configured to transmit a lock status and a camera output to a remote computing device via said wireless receiver.

11. A method of securing a door to a frame using a door security system, the method comprising:
mounting a locking mechanism to an at least one of the door and the frame, said locking mechanism comprising:
a turning latch disposed within said locking mechanism and rotatable between an unlocked position and a locked position;
a thumb turn mechanically coupled to said turning latch and operable to rotate said turning latch between said locked position and said unlocked position;
a release mechanism and a servo configured to trigger a rotation of said turning latch from said unlocked position to said locked position;
a microcontroller operatively connected to said servo and configured to transmit an electronic control signal to the servo upon receiving an activation input, said electronic control signal causing said servo to trigger said rotation;
a wireless receiver operatively connected to said microcontroller and configured to receive a signal from a remote control; and
a power supply configured to supply electrical power;
mounting a strike receiver to the other of said at least one of the door and the frame;
positioning said strike receiver such that said turning latch of the locking mechanism engages said strike receiver when the door is in a closed position;
installing a conduit extending from said locking mechanism extending to an exterior-facing surface of said at least one of the door and the frame and housing in said conduit at least a connection between said microcontroller and a status light;
engaging said locking mechanism via one of said release mechanism and said remote control; and
activating said status light to visibly illuminate on said exterior-facing surface of said at least one of the door and the frame to indicate a state of said locking mechanism.

12. The method of claim 11, further comprising emitting a first light color from the status light when the turning latch is in said locked position and a second light color when the turning latch is in said unlocked position.

13. The method of claim 11, further comprising detecting a position of the turning latch using a sensor operatively connected to said microcontroller and transmitting a corresponding signal to said microcontroller.

14. The method of claim 11, wherein said release mechanism comprises a spring-loaded catch, and further comprising retaining said turning latch in said unlocked position and releasing said catch to rotate said turning latch to said locked position under a stored spring force.

15. The method of claim 11, wherein said servo is a bidirectional servo, and further comprising rotating said turning latch from said locked position to said unlocked position and from said unlocked position to said locked position in response to a signal received by said microcontroller.

16. The method of claim 11, further comprising capturing video of an interior-facing space using a camera mounted to said locking mechanism and operatively connected to said microcontroller.

17. The method of claim 11, wherein said power supply comprises a rechargeable battery removably mounted within the locking mechanism.

18. The method of claim 17, further comprising removing said locking mechanism from said at least one of the door and the frame to recharge said battery.

19. The method of claim 11, further comprising fastening the status light to said exterior-facing surface of the door or the frame using a security screw, and mechanically coupling the conduit to the turning latch such that removal of the security screw permits a rotation of the turning latch from a locked position to an unlocked position.

20. The method of claim 16, further comprising transmitting a lock status and camera output from said microcontroller to a remote computing device via said wireless receiver.
